(19) United States
(12) Patent Application Publication
(10) Pub. No.: US 2014/0130654 A1
(43) Pub. Date: May 15, 2014

(54) Method and Apparatus for Exploring Chord Progressions Within a Mode of a Diatonic Major Key

(71) Applicant: John Pasco Rowe, McKinney, TX (US)

(72) Inventor: John Pasco Rowe, McKinney, TX (US)

(21) Appl. No.: 13/674,036

(22) Filed: Nov. 11, 2012

(51) Int. Cl. G10H 1/38

(52) U.S. Cl. CPC G10H 1/38
USPC 84/613

(57) ABSTRACT

A method for generating a chord progression within a mode of a diatonic major key may include the steps of casting a first cube to define a chord matrix from a plurality of chord matrices based upon a diatonic major key, casting a second cube to select the mode of the diatonic major key from the chord matrix, casting the second cube to determine a chord progression and playing an instrument based upon the mode of the diatonic major key and the chord progression.

### PRIORITY

The present invention claims priority under 35 USC section 119 based upon a provisional application filed on and with a Ser. No. of 61/628,968 which was filed on Nov. 10, 2011.

### RELATED APPLICATIONS

The present application is a CIP application of pending application Ser. No. 13/493,818 which was filed on Jun. 11, 2012.

### FIELD OF THE INVENTION

The instant invention relates generally to a game and more specifically it relates to a music composition method which provides a plurality of playing cubes. Additionally, the present invention includes a strategy for choosing a pattern for a musical instrument.

### BACKGROUND

U.S. Pat. No. 7,396,988 which is incorporated by reference in its entirety discloses a music composition method and apparatus including a plurality of small playing cubes each having a color-coded musical chord with a number to indicate the position of the chord within the matching color-coded musical key of a separate, larger cube indicated on each side thereof. A color-coded device is provided to guide the placement of playing cubes into sequences of chord progressions thereon after the playing cubes are cast upon a flat surface. A player can form multiple chord progressions from the chords on the top sides of the cast playing cubes and play the cast sequence of chords on their instrument thereby learning the relationship between the chords belonging to a musical key.

### SUMMARY

A method for generating a chord progression within a mode of a diatonic major key may include the steps of casting a first cube to define a chord matrix from a plurality of chord matrices based upon a diatonic major key. casting a second cube to select the mode of the diatonic major key from the chord matrix, casting the second cube to determine a chord progression and playing an instrument based upon the mode of the diatonic major key and the chord progression.

The step of casting the first cube may select the matrices based upon the diatonic major key.

The mode may be Ionian.

The mode may be Dorian.

The mode may be Phrygian.

The mode may be Lydian.

The mode may be Mixolydian.

The mode may be Aeolian.

The mode may be Locrian.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a table corresponding to the use of a octahedron of the present invention;

FIG. 2 illustrates a table corresponding to the use of a dodecahedron of the present invention;

FIG. 3 illustrates a table corresponding to the use of a cube of the present invention;

FIG. 4A-4B illustrates the faces of the octahedron of the present invention;

FIG. 5A-5B illustrates the faces of the dodecahedron of the present invention;

FIG. 6A-6B illustrates the faces of the cube of the present invention.

FIG. 7 illustrates a perspective view of the dodecahedron of the present invention;

FIG. 8 illustrates a perspective view of the cube of the present invention;

FIG. 9 illustrates the faces of the octahedron of the present invention;

FIG. 10 illustrates the first faces of a first cube of the present invention;

FIG. 11 illustrates the second faces of a second cube of the present invention;

FIGS. 12-23 illustrates the 1-12 matrices of the present invention;

FIG. 24 illustrates a perspective view of the first or second (third or fourth) cube;

FIG. 25 illustrates the chart for the third cube;

FIG. 26 illustrates the chart for the fourth cube;

FIG. 27 illustrates the indicia for the third cube;

FIG. 28 illustrates the indicia for the fourth cube.

### DETAILED DESCRIPTION

The game of the present invention may be played by one person but two or more participants are always better; however, this invention does not necessarily promote competition between players. This invention is intended to inspire and promote learning and creativity with a musical instrument.

The game of the present invention includes a multitude of octahedrons for example 12 (other numbers of octahedrons are within the scope of the invention), a dodecahedron, a cube and a strategy for choosing a strumming and rhythm pattern for a musical instrument which may be a guitar or banjo.

Each of the octahedrons may include 8 sides, and each side may include a scale step and its corresponding chord within a diatonic major key (one side may include a logo). The first side of the first octahedron may correspond to the scale steps and chords of the diatonic key of C major, the second octahedron may correspond to the scale steps and chords of the diatonic key of G major, the first side of the third octahedron may correspond to the scale steps and chords of the diatonic key of D major, the first side of the fourth octahedron may correspond to the scale steps and chords of the diatonic key of A major, the first side of the fifth octahedron may correspond to the scale steps and chords of the diatonic key of E major, the first side of the sixth octahedron may correspond to the scale steps and chords of the diatonic key of B major, the first side of the seventh octahedron may correspond to the scale steps and chords of the diatonic key of F# (F sharp) major and Gb (G Flat) major, the first side of the eighth octahedron may correspond to the scale steps and chords of the diatonic key of Db (D flat), the first side of the ninth octahedron may correspond to the scale steps and chords of the diatonic key of Ab major, the first side of the tenth octahedron may correspond to the scale steps and chords of the diatonic key of Eb major, the first side of the eleventh octahedron may correspond to the scale steps and chords of the diatonic key of Bb major and the first side of the twelfth octahedron may correspond to the scale steps and chords of the diatonic key of F major.

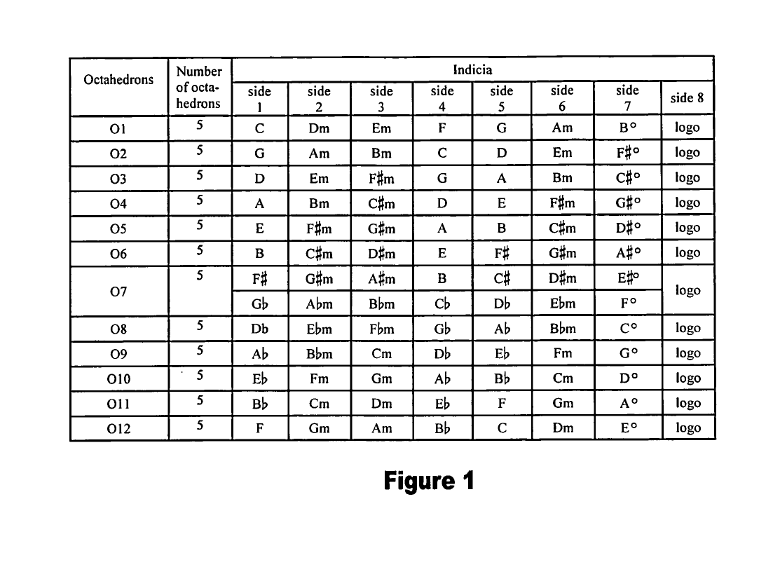

FIG. 1 illustrates a table which corresponds to a summary of the scale steps and chords of the diatonic key where each row of the first table corresponds to a different octahedron and the columns correspond to the side of the octahedron.

An example of the detailed description about the 8 sides of each octahedron follows.

Side 1 of each octahedron may correspond to the 1st scale step (as indicated by the ‘1’ indicia) and its corresponding chord within the diatonic major key which may be determined by the 1st scale step.

Side 2 of each octahedron may correspond to the 2nd scale step (as indicated by the ‘2’ indicia) and its corresponding chord within the diatonic major key which may be determined by the 1st scale step.

Side 3 of each octahedron may correspond to the 3rd scale step (as indicated by the ‘3’ indicia) and its corresponding chord within the diatonic major key which is determined by the 1st scale step.

Side 4 of each octahedron may correspond to the 4th scale step (as indicated by the ‘4’ indicia) and its corresponding chord within the diatonic major key which may be determined by the 1st scale step.

Side 5 of each octahedron may correspond to the 5th scale step (as indicated by the ‘5’ indicia) and its corresponding chord within the diatonic major key which may be determined by the 1st scale step.

Side 6 of each octahedron may correspond to the 6th scale step (as indicated by the ‘6’ indicia) and its corresponding chord within the diatonic major key which may be determined by the 1st scale step.

Side 7 of each octahedron may correspond to the 7th scale step (as indicated by the ‘7’ indicia) and its corresponding chord within the diatonic major key which may be determined by the 1st scale step.

Side 8 of each octahedron may correspond to a wild card that can be re-rolled or when the wild card is cast it can be removed from the chord progression or the wild card can act as silence in the song.

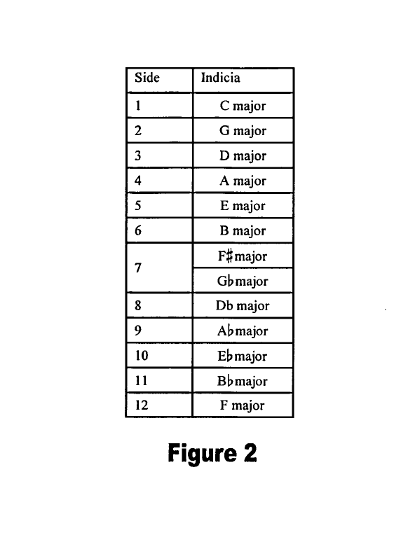

FIG. 2 illustrates the 12 sides of the dodecahedron which illustrates the corresponding diatonic major key.

The player throws the dodecahedron and the side facing up determines the diatonic major key. If the second side comes up then the steps and chords of the diatonic key of G major is to be used by the player. More particularly, the side of the dodecahedron facing up determines the row in the first table. The row additionally indicates the number of times that a selected octahedron is to be cast, and each time a octahedron is cast the scale steps of the major key is selected for the player. Row 2 indicates that the selected octahedron is to be cast five times. The first cast of the octahedron comes up side 1 to indicate that the player plays G; the second cast of the octahedron comes up side 4 to indicate the player plays C; the third cast of the octahedron comes up side 5 to indicate that the player plays D; the fourth cast of the octahedron comes up side 6 to indicate that the player plays Em (E minor); and the fifth cast of the octahedron comes up side 5 to indicate that the player plays D.

Other rows include F# to indicate that F sharp should be played by the player, and E° to indicate E diminished should be played, and Dm to indicate that D minor should be played.

Each side of the octahedron may include indicia which corresponds to the scale step of the major key and a multitude of chords formed by the scale step.

In summary, the player throws the dodecahedron to determine the diatonic major key and the player next throws the octahedron corresponding to the selected diatonic major key to select a first chord. The player throws the octahedron the number of times corresponding to the number of octahedrons indicated in the table of FIG. 1. This determines the chord progression.

Each octahedron may be color-coded to facilitate fast and easy recognition of the octahedron.

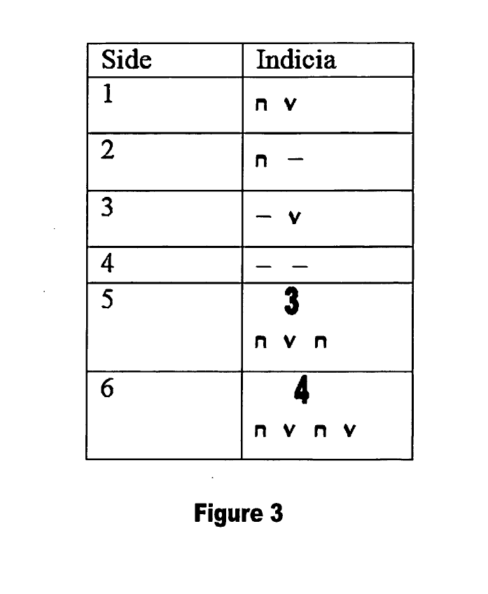

Next the player obtains a strategy for choosing a strumming and rhythm pattern which may be required to cast as many cubes as desired. The strategy is obtained by casting a specially marked cube. FIG. 3 illustrates the cube sides where ‘n’ is a downbeat,'v′ is an upbeat and ‘−’ is a rest or miss on the guitar strings.

In an example, the musician may cast six cubes. The results are that the musician casts a side 1, a side 2, a side 3, a side 4, a side 5, and a side 6. Using a common chord, the player would strum the chord as follows:

Down/up (side 1)/down/Miss (side 2)/Miss/up (side 3)/Miss/Miss (side 4)/triple strum (down/up/down) (side 5) and/quadruple strum (down/up/down/up) (side 6).

FIG. 3 illustrates a table corresponding to the use of a cube of the present invention;

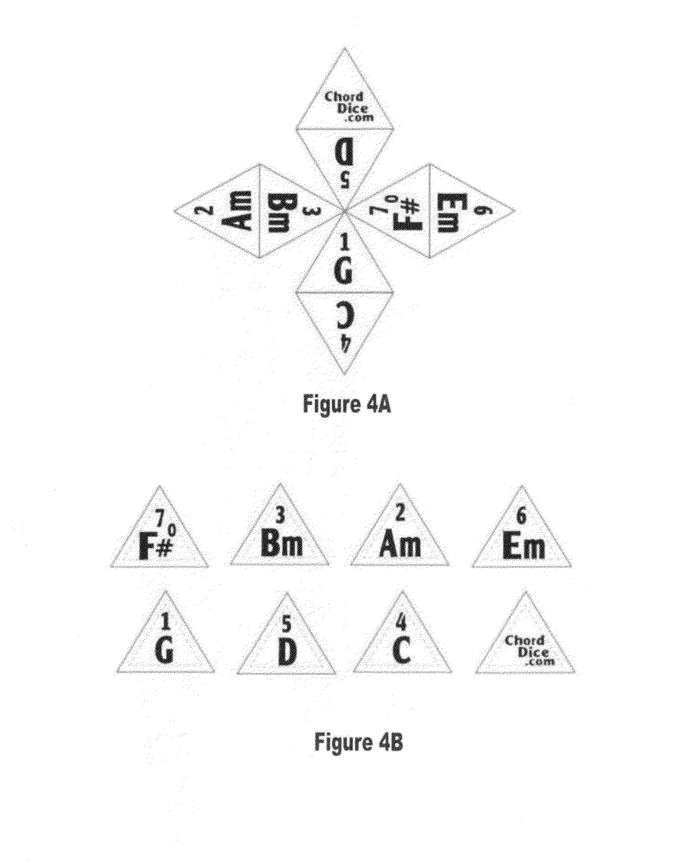

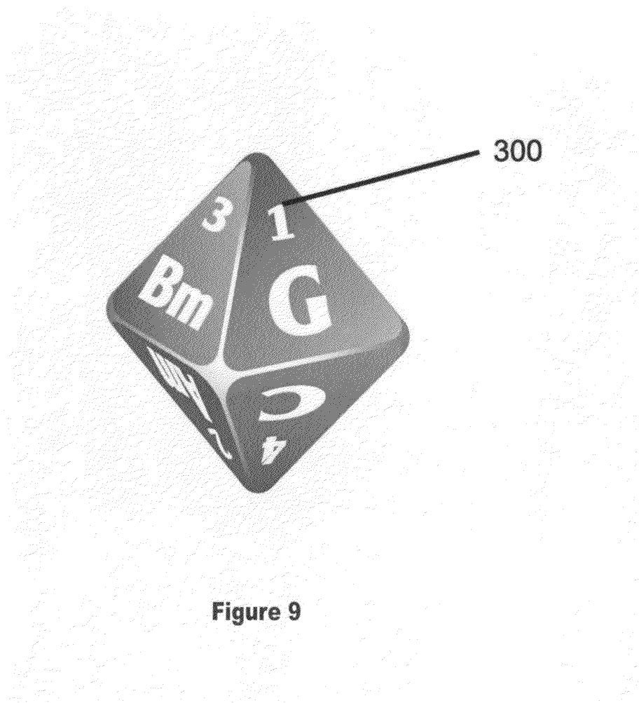

FIG. 4A-4B and 9 illustrates the faces of the octahedron 300 of the present invention;

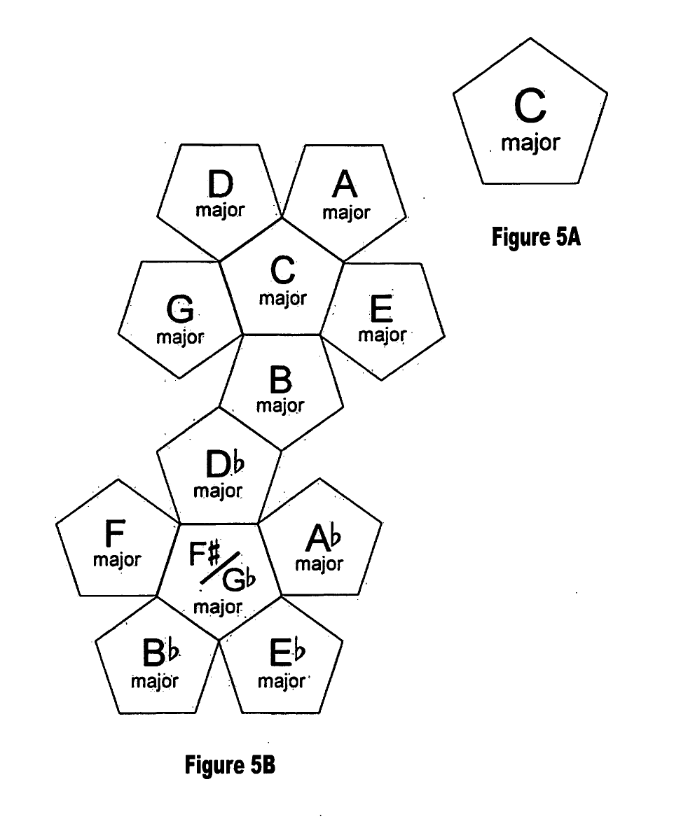

FIG. 5A-5B illustrates the faces of the dodecahedron 300 of the present invention;

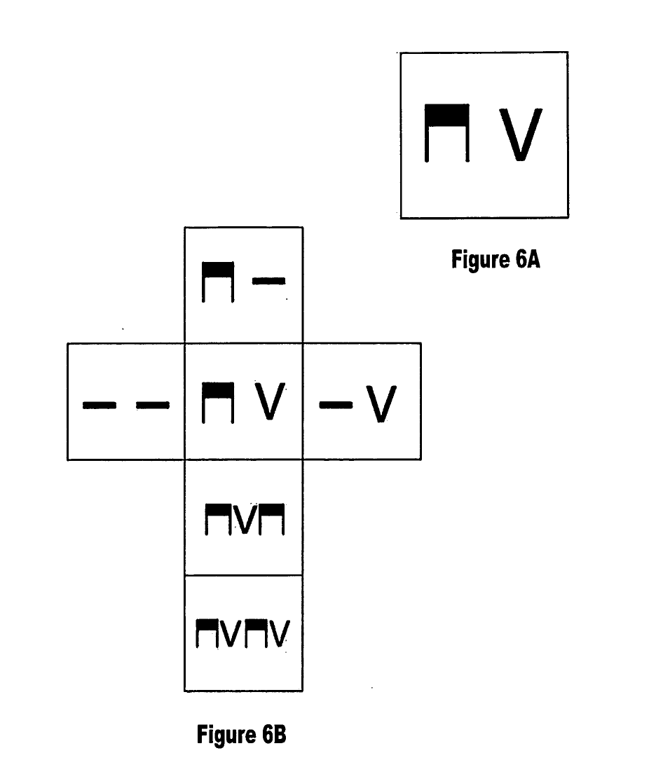

FIG. 6A-6B illustrates the faces of the cube 600 of the present invention.

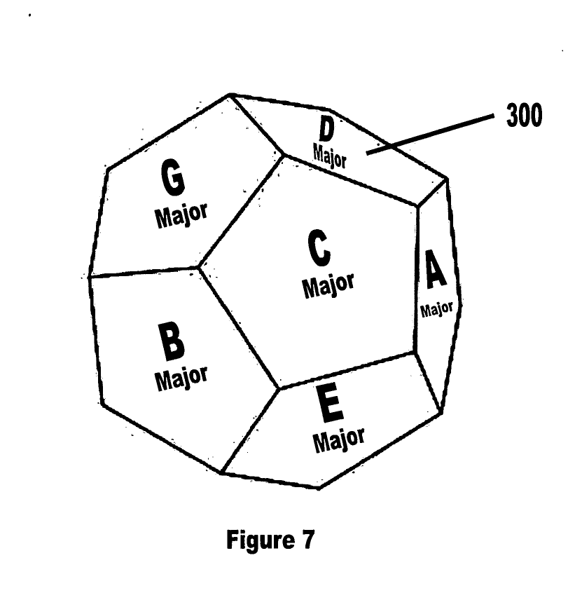

FIG. 7 illustrates a perspective view of the dodecahedron 300 of the present invention;

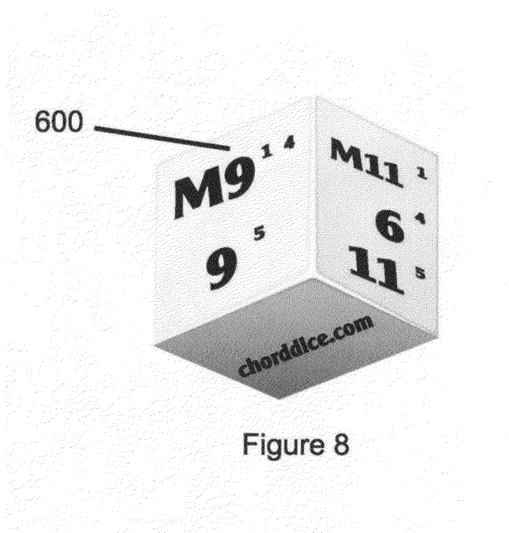

FIG. 8 illustrates a perspective view of the cube 600 of the present invention.

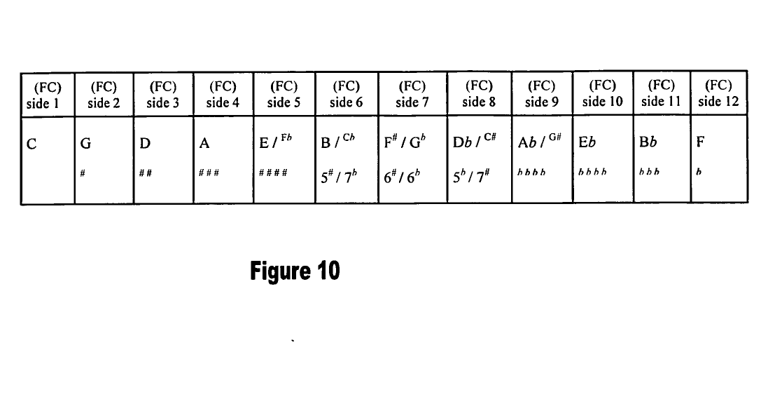

FIGS. 10-23 illustrates another aspect of the present invention.

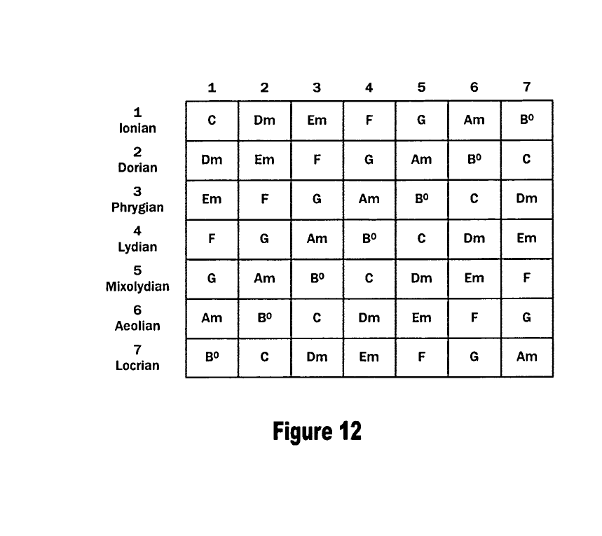

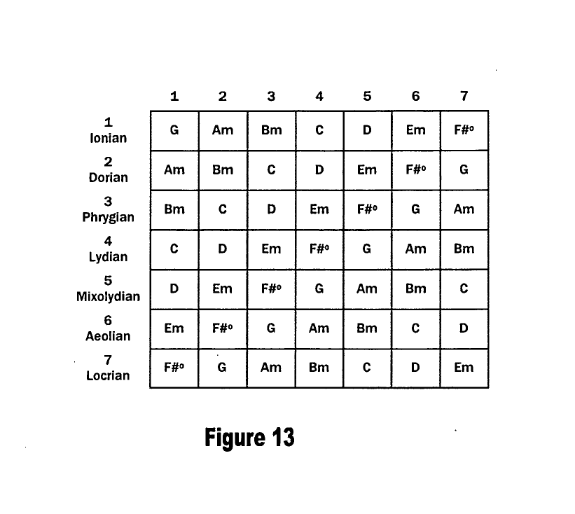

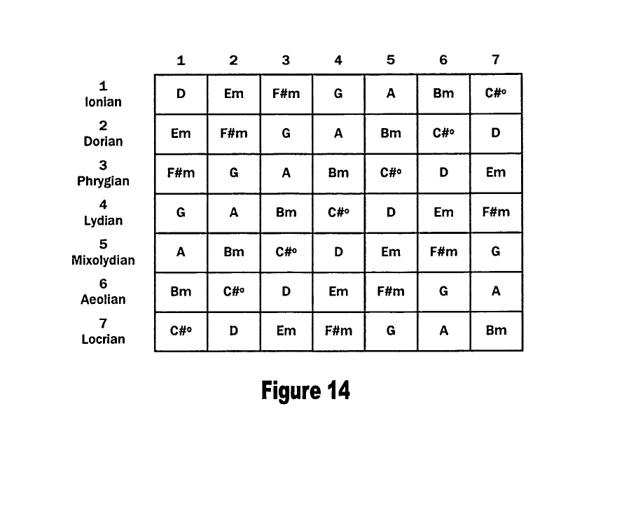

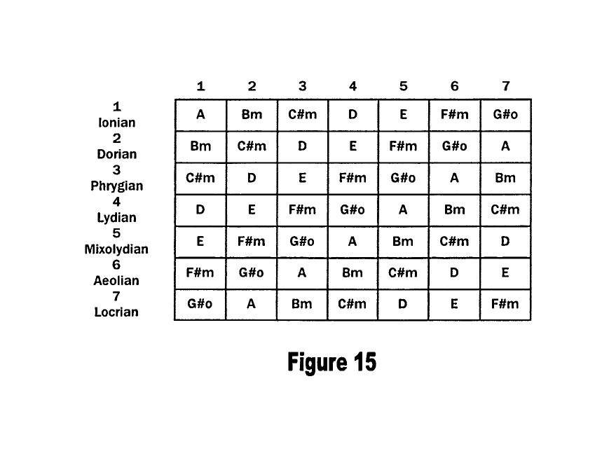

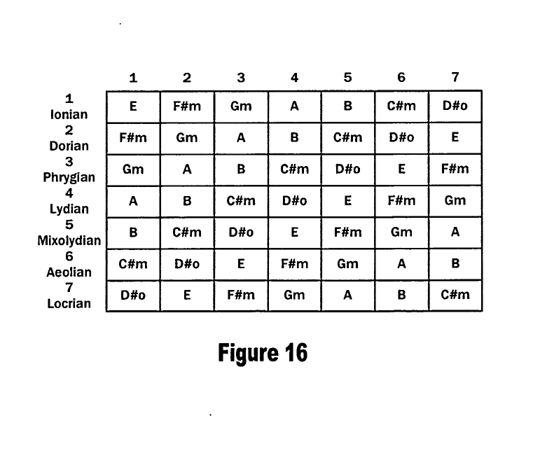

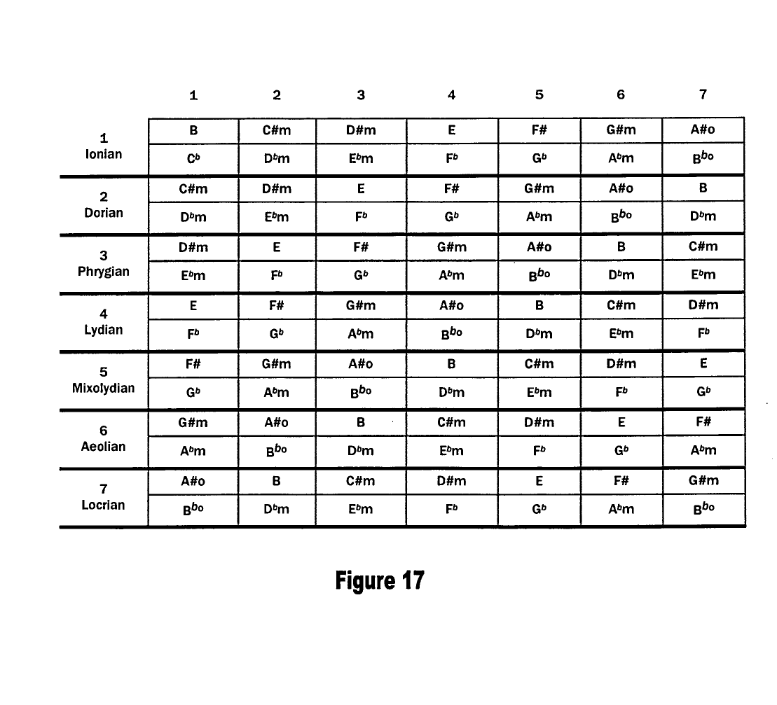

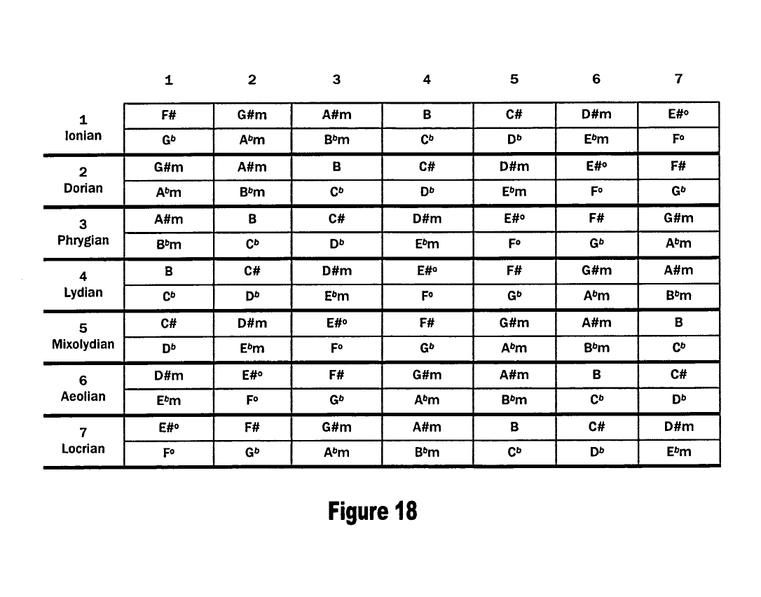

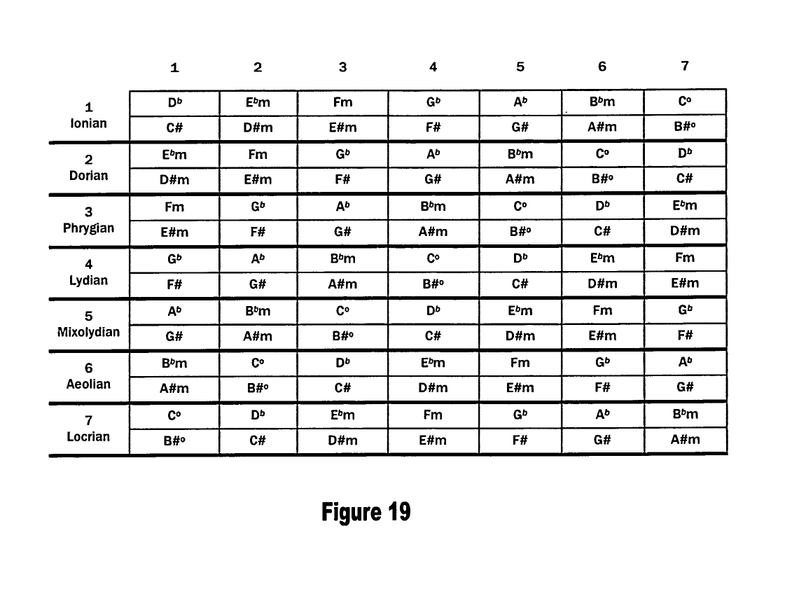

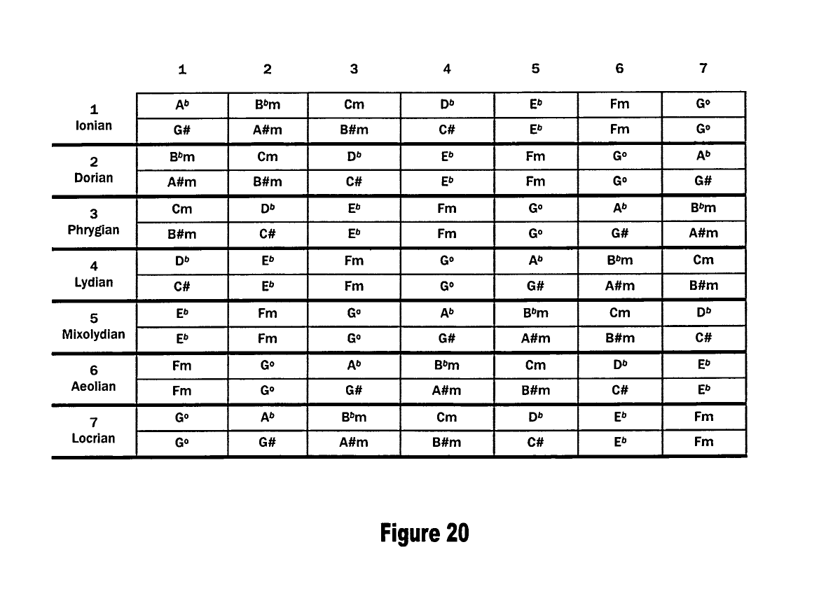

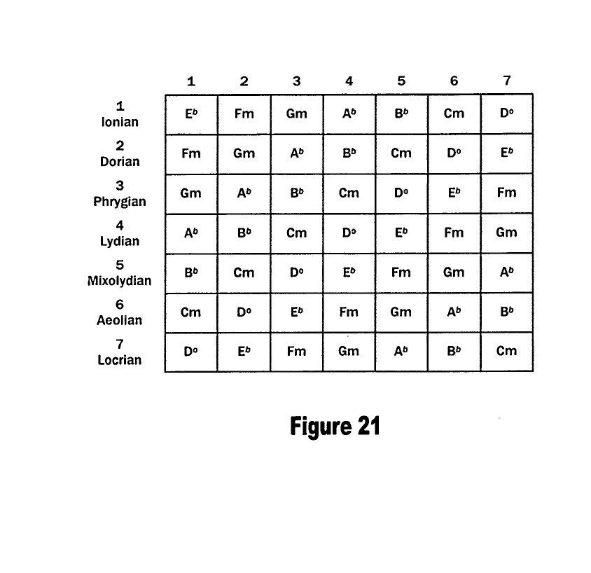

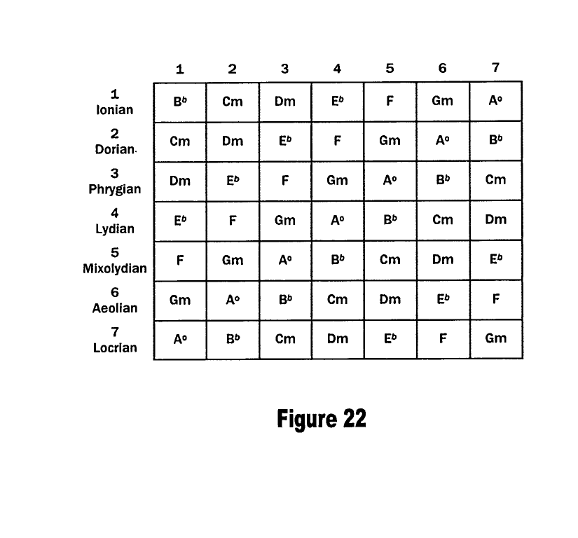

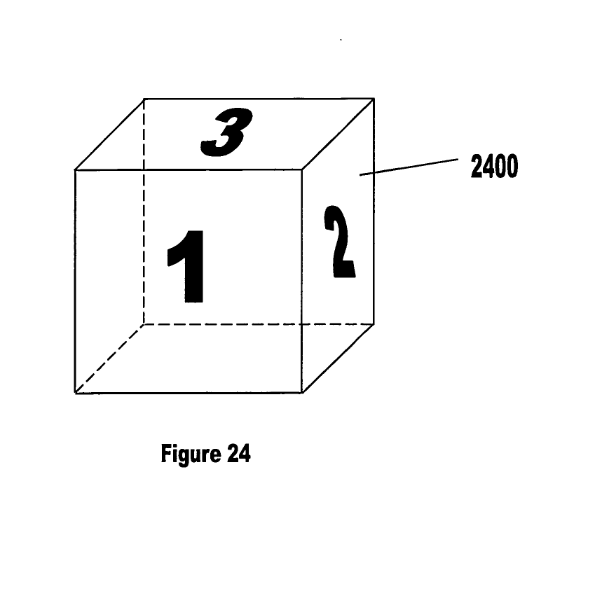

The present invention may include a plurality of casting cubes 2400 in FIG. 24 which may include a first cube, and a second cube, and a plurality of chord matrices in FIGS. 12-23 which may include a first matrix illustrated in FIG. 12, a second matrix illustrated in FIG. 13, a third matrix illustrated in FIG. 14, a fourth matrix illustrated in FIG. 15, a fifth matrix illustrated in FIG. 16, a sixth matrix illustrated in FIG. 17, a seventh matrix illustrated in FIG. 18, an eighth matrix illustrated in FIG. 19, a ninth matrix illustrated in FIG. 20, a tenth matrix illustrated in FIG. 21, an eleventh matrix illustrated in FIG. 22, and a twelfth matrix illustrated in

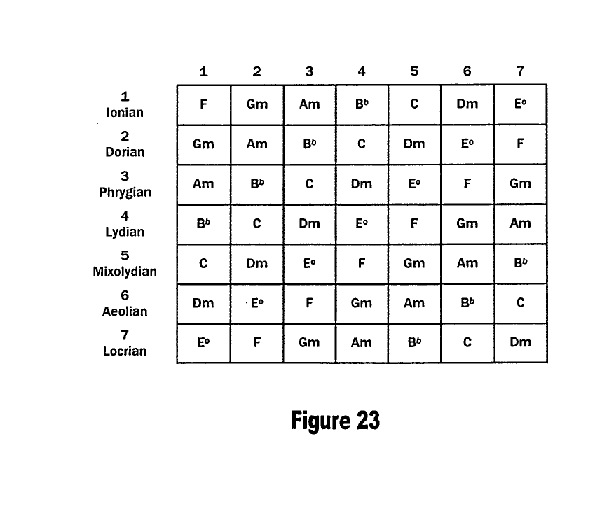

FIG. 23 that contain the chords of a diatonic major key, and a method to select a chord progression within a mode of the diatonic major key.

Indicia on the first cube refer to the diatonic major keys as shown in FIG. 10. Each side includes indicia to indicate the number of side showing, for example the first side. The first side has indicia to indicate the diatonic major key of C.

The second side has indicia to indicate the diatonic major key of G. The third side has indicia to indicate the diatonic major key of D. The fourth side has indicia to indicate the diatonic major key of A. The fifth side has indicia to indicate the diatonic major key of E/^{Fb}. The sixth side has indicia to indicate the diatonic major key of B/^{Cb}. The seventh side has indicia to indicate the diatonic major key of F^{#}/G^{b}. The eighth side has indicia to indicate the diatonic major key of Db/^{C#}. The eighth side has indicia to indicate the diatonic major key of Db/^{C#}. The ninth side has indicia to indicate the diatonic major key of Ab/^{G#}. The tenth side has indicia to indicate the diatonic major key of Eb. The eleventh side has indicia to indicate the diatonic major key of Bb. The twelfth side has indicia to indicate the diatonic major key of F.

Indicia on the first cube (FC) will be labeled according to the chart as shown in FIG. 10.

Indicia on the second cube refer to a chord within the mode of the diatonic major key.

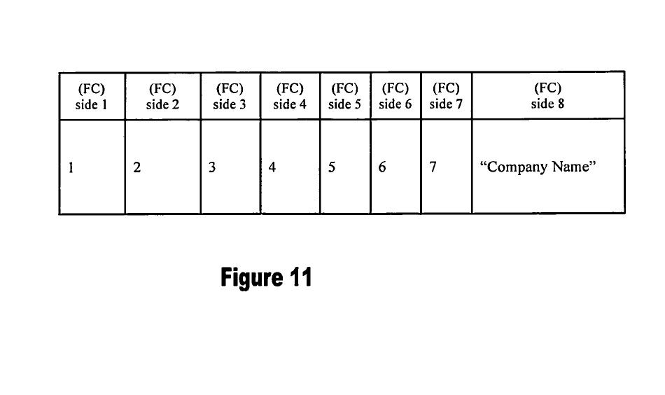

Indicia on the second cube (SC) will be labeled according to the chart as shown in FIG. 11. The first side has an indicia of 1. The second side has an indicia of 2. The third side has an indicia of 3. The fourth side has an indicia of 4. The fifth side has an indicia of 5. The sixth side has an indicia of 6. The seventh side has an indicia of 7. The eighth side has an indicia of a company name or other appropriate indicia.

Indicia on the matrices as shown in FIGS. 12-23 refer to the chords that relate to the modes within the diatonic key.

The method for selecting the chord progression within the mode of the diatonic major key consists of three components: a first casting strategy to select a diatonic major key, a second casting strategy to select a mode of the selected diatonic major key, and a sequencing strategy to select a chord progression of chords within the selected mode of the selected diatonic major key.

The first casting strategy to select the diatonic major key requires a musician to cast the first cube illustrated in FIG. 7. If the musician casts side 2, the diatonic key of G major is selected as is shown on the first cube. This casting defines that the second matrix is to be used which is illustrated in FIG. 13.

The second casting strategy to select a mode of the selected diatonic G major key requires the musician to cast the second cube illustrated in FIG. 24. If the musician casts side 2, the Dorian mode of the diatonic key of G major is selected by virtue of the 2 on the second side of the cube and by virtue of the second row of the matrices (second matrix) which is illustrated in FIG. 13 and corresponds to the Dorian mode. If the musician casts side 3, the Phrygian mode of the diatonic key of G major is selected by virtue of the 3 on the second side of the cube and by virtue of the third row of the matrices correspond to the Phrygian mode.

The sequencing strategy to select a chord progression of chords within the selected Dorian mode of the selected diatonic G major key requires the musician to cast a plurality of second cubes. If the musician casts (side 1, side 4, side 6, and side 5), the musician will play the chord progression (Am, D, F#°, Em) on a musical instrument as indicated by the second matrix's second row labeled “2 Dorian”. The cast of the cube determines the chord progression by choosing the column of the second row of the second matrix.

Below find another embodiment of the present invention which may be referred to as ‘A Method and Apparatus for Exploring Substitute Chords Within a Diatonic Major Key’.

The present invention may include a third cube, a fourth cube, and a strategy for choosing a substitute chord within a diatonic major key.

Indicia on the third cube refers to a variety of major chords that may substitute a 1, 4, or 5 major chord within the diatonic major key.

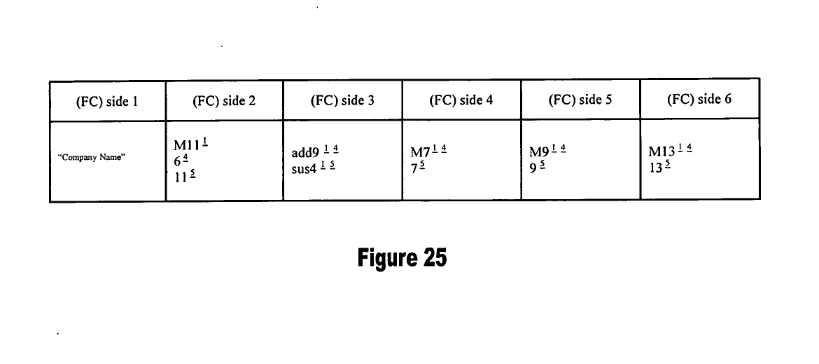

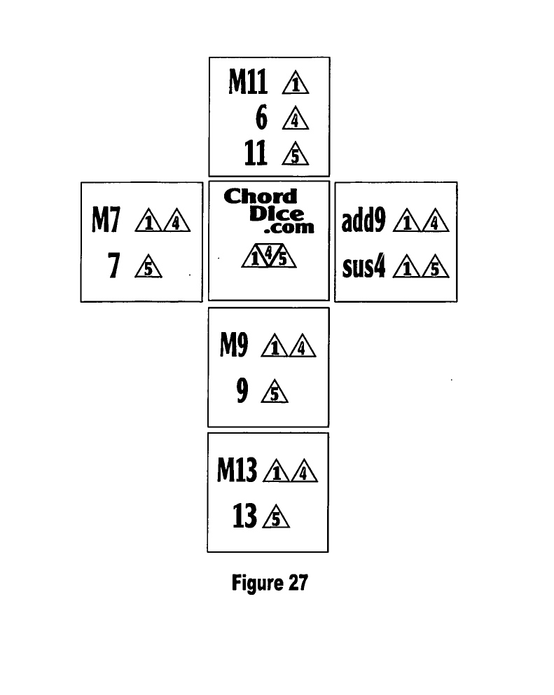

Indicia on the third cube (TC) will be labeled according to the chart as illustrated in FIG. 25 and the cube face layout in FIG. 27.

Indicia on the fourth cube refers to a variety of minor chords that may substitute a 2, 3, or 6 minor chord or a half-diminished chord that may substitute a 7 diminished chord within the diatonic major key.

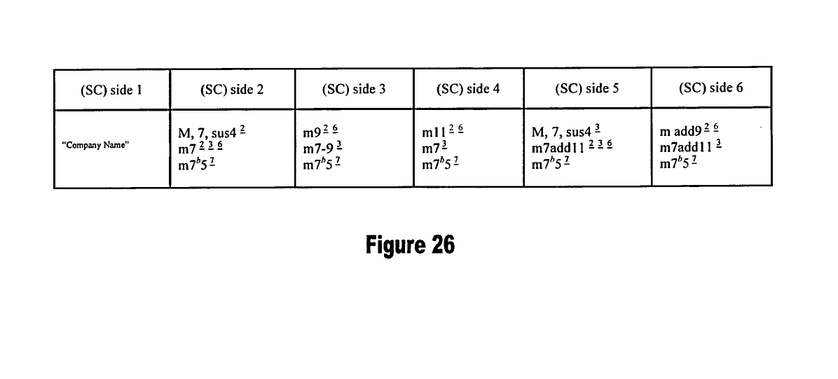

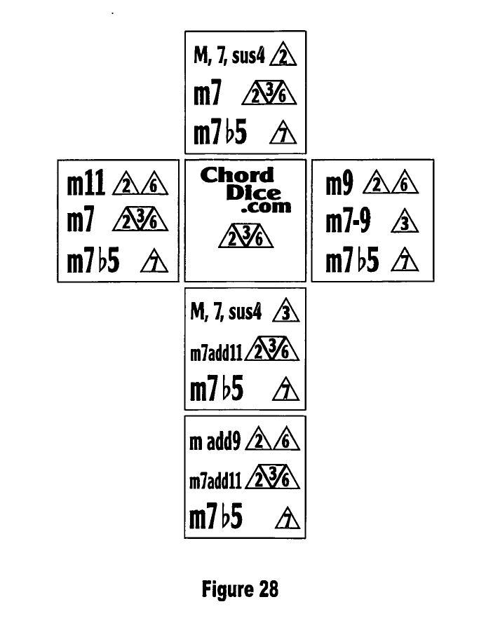

Indicia on the fourth cube (FC) will be labeled according to the chart in FIG. 26 and the cube layout in FIG. 28.

The strategy for choosing the substitute chord within the diatonic major key may include two components: a casting strategy and a substitution strategy.

The casting strategy requires a musician to cast the first cube in FIG. 27 to substitute a major chord and the second casting cube in FIG. 28 to substitute a minor or diminished chord.

The substitution strategy determines the substitute chord.

Example: If the musician wants to substitute the 4 chord within the diatonic key of G major, the musician casts the third cube in FIG. 27. If side 5 is cast on the third cube, the musician could substitute a D Major chord for a DM9 according to the chart in FIG. 25.

Example: If the musician wants to substitute the 3 chord within the diatonic key of G major, the musician casts the fourth cube in FIG. 28. If side 5 is cast on the fourth cube, the musician could substitute a B minor chord for a BM, B7, Bsus4, or Bm7add11 according to the chart in FIG. 26.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A method for generating a chord progression within a mode of a diatonic major key, comprising the steps of:
casting a first cube to define a chord matrix from a plurality of chord matrices based upon a diatonic major key;
casting a second cube to select the mode of the diatonic major key from the chord matrix;
casting the second cube to determine a chord progression; and
playing an instrument based upon the mode of the diatonic major key and the chord progression.

2) A method for generating a chord progression within a mode of a diatonic major key as in claim 1, wherein the step of casting the first cube selects the matrices based upon the diatonic major key.

3) A method for generating a chord progression within a mode of a diatonic major key as in claim 1, wherein the mode is Ionian.

4) A method for generating a chord progression within a mode of a diatonic major key as in claim 1, wherein the mode is Dorian.

5) A method for generating a chord progression within a mode of a diatonic major key as in claim 1, wherein the mode is Phrygian.

6) A method for generating a chord progression within a mode of a diatonic major key as in claim 1, wherein the mode is Lydian.

7) A method for generating a chord progression within a mode of a diatonic major key as in claim 1, wherein the mode is Mixolydian.

8) A method for generating a chord progression within a mode of a diatonic major key as in claim 1, wherein the mode is Aeolian.

9) A method for generating a chord progression within a mode of a diatonic major key as in claim 1, wherein the mode is Locrian.
